(19) United States
(12) Patent Application Publication
(10) Pub. No.: US 2007/0280357 A1
(43) Pub. Date: Dec. 6, 2007

(54) Device for video decompression and display

(76) Inventor: Chih-Ta Star Sung, Glonn (DE)

Correspondence Address: Chih-Ta Star Sung;RM. 308, BLD. 52, NO. 195, CHUNG HSING RD., SEC. 4, JHU DONG TOWNSHIP, HSINCHU COUNTY, 310, omitted

(21) Appl. No.: 11/443,522

(22) Filed: May 31, 2006

(51) Int. Cl. H04N 11/02; H04N 7/12

(52) U.S. Cl. 375/240.25; 375/240.26

(57) ABSTRACT

A device of decompressing video data, scaling the image and displaying to a displaying device significantly reduces the power consumption. The compressed video data is reconstructed and temporarily compressed before storing into a temporary display frame buffer and decompressed before displaying in a display device. A video data is partially decoded to the DCT domain and scaled according to the resolution of display before the video decompression. A video communication device includes an image sensor integrated together with the video compression engine into the same die and a display driver with the video decompression engine integrated together in the same die.

### BACKGROUND OF THE INVENTION

1. Field of Invention

The present invention relates to image decompression and display, and more particularly relates to the video decompression and temporary image buffer compression/decompression for display device which significantly reduces the power consumption and the density requirement hence the cost of the temporary storage device.

2. Description of Related Art

The sharp quality of new display devices like the Liquid Crystal Display, LCD devices coupled with manufacturing cost reduction in the past years have driven mass production of the new display products in wide applications. Which includes display panels of mobile devices like digital display panel, PC screen panel, portable DVD player, digital still camera (DSC), digital video recorder (DVR), mobile phone, toys with display panel, electronic dictionary, telephony panel, video phone, . . . etc.

MPEG is one of the most popular video compression standard set by ISO, has mass production market including MPEG2 in DVD. Another popular video compression standard is the H.26x (H.261 and H.263) in the video conference application which is set by ITU, another international organization for standard setting. ISO and ITU has jointly developed another video compression and decompression standard, names H,264 or AVC (Advanced Video Coding) which has been widely adopted in digital TV, 3G mobile phone, new HD DVD, . . . and many others.

Decompressing video stream costs high computing power as well as high power consumption. A controller drives the reconstructed video with most common 30 frames per second, or 30 fps will be driven to the display device at a rate of ˜60 fps through a data bus. Transferring the reconstructed video data to the display device, for example, the TFT LCD, Thin Film Transistor Liquid Crystal Display dissipates high power since the amount of data of the decompressed video is high. The frame of image being displayed can also be temporarily saved in the on-chip storage device, a frame buffer, within the display driver, but the frame buffer costs high die area and dissipates high power during reading and refreshing the display frame.

Therefore, it is beneficial to reduce the required amount of storage devices of the on-chip reference frame buffer to further reduce the cost and power consumption and for further reducing the power consumption when transferring the image data from a video decompressing engine to the display driver.

### SUMMARY OF THE INVENTION

The present invention is related to an apparatus of the image decompression for display device, which plays an important role in significantly reducing the power consumption in video decompression and display frame buffer and required storage device density for the referencing frame as well as the display frame buffer.

The present invention of the video decompression and display integrates a video decompression engine into a display driver with display image frame buffer and a display timing control together which significantly reduces the power consumption in video decompression and display.

According to an embodiment of the present invention of the video decompression and display, an image compression codec compresses the image to be displayed before storing to the frame buffer and decompressing it before driving out to the display driver and display panel.

According to an embodiment of the present invention of the video decompression and display, the video decompression engine includes a referencing frame buffer with image being compressed before saving into the referencing frame buffer and decompressed before feeding to the video decompression engine.

According to an embodiment of the present invention of the video decompression and display, a scaling engine is applied to reduce the compressed video data rate according to the resolution of the display panel before video decompression.

According to an embodiment of the present invention of the video decompression and display, part of the video decompression function is done by executing instructions in a CPU.

According to another embodiment of the video decompression and display, the instructions used to decompressing the video data is compressed before saving to the program memory and is accessed and decompressed before sending to the execution unit of the CPU.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of a video decompression and display system having a reconstructed video driving to the display driver with 60 frame per second refreshing rate.

FIG. 2 illustrates a prior art of a driver chip with a large frame buffer, source drivers and/or gate drivers.

FIG. 3 depicts the details of the block diagram of the commonly designed display driver with an on-chip SRAM as a frame buffer.

FIG. 4 depicts this invention of video decompression and display device with decompression and display driving circuitry on the same chip to significantly reduce the power consumption.

FIG. 5 depicts a prior art of decompressing the video data, scaling and display to a display device.

FIG. 6 depicts the invention of scaling the compressed video data and decompressing the scaled display before sending to a display device.

FIG. 7 depicts the procedure of the video decompression with referencing frame buffer compression and decompression.

FIG. 8 illustrates a block diagram of video decoding engine with CPU/DSP and some hardwired ASIC blocks hooking to data bus.

FIG. 9 depicts the block diagram of a CPU functioning as a video decompression engine by running firmware instructions which is compressed before being fed to the program memory and decompressed before being executed by the ALU engine.

FIG. 10 illustrates the block diagram of a video communication system with video compression engine integrated to the image sensor and the video decompression engine integrated with the display driver.

### DESCRIPTION OF THE PREFERRED EMBODIMENTS

In the past decade, new display devices including LCD, Liquid Crystal Display, has reached high quality of display which created wide applications including display panels of mobile devices like digital TV panel, PC screen panel, portable DVD player, digital still camera (DSC), digital video recorder (DVR), mobile phone, electronic dictionary, telephony panel, video phone, . . . etc.

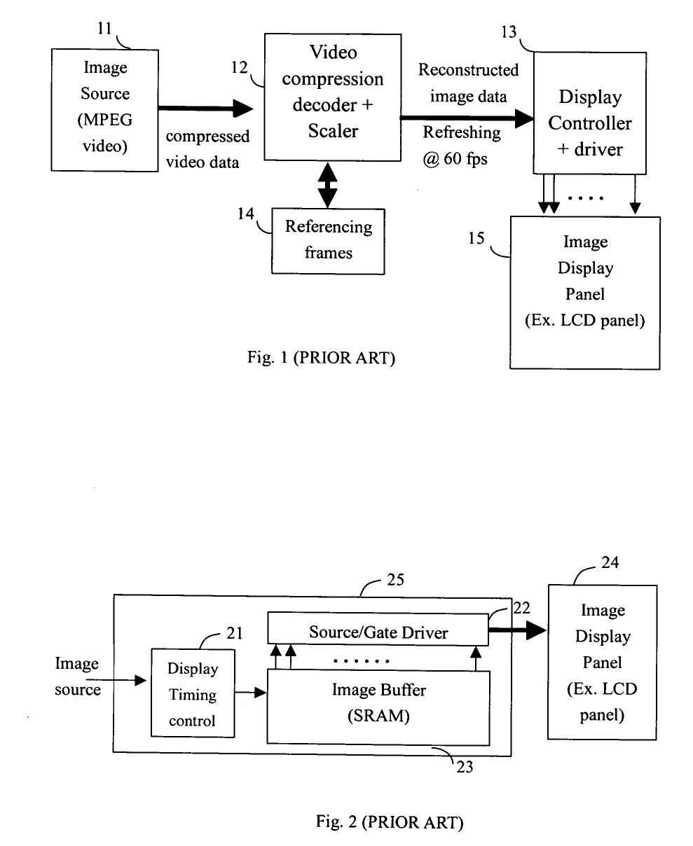

Digital video has created mass markets including DVD. In the future, with enhanced digital video compression algorithms, the HD DVD (High Definition DVD of 15-30 Giga Byte) will allow even higher resolution and quality of video to be stored and displayed. A display system, for example, an LCD panel, is like a traditional TV with the image displayed line by line sequentially. Most prior art digital video decompression, scaling and display systems are comprised of the three main devices as shown in FIG. 1: the video decompression engine 12 with a referencing memory 14, the scaling engine 12 and the display device 15 with a display drive 13. In most display panel, the display driver is placed to the panel to drive out the frame pixels under a rate like 60 frame per second, or 60 fps depending on the material of the display device. The video source is a compressed video data like MPEG video or a JPEG picture 11.

FIG. 2 shows the prior art display system comprising of a display panel 24 and a display driver 22 with a display timing controller 21, a display driver 22 and a frame buffer 23. Since display driver, for example, the LCD driver resides a lot of MOS transistors which need to conduct relatively high voltages compared to common used power supply voltage (ex. 3.3V in 0.35 um process) of MOS process, to avoid device breakdown effect, the channel length of the drivers are much longer than regular MOS devices hence dominate large die area. In multimedia era, larger and larger resolution of image is integrated into the frame buffer which is commonly comprised of SRAM memory array within a display driver which makes the die area of a display driver even larger. The larger the die area, the lower the yield a chip can obtain and the higher power it will consume through the leak of parasitic diode.

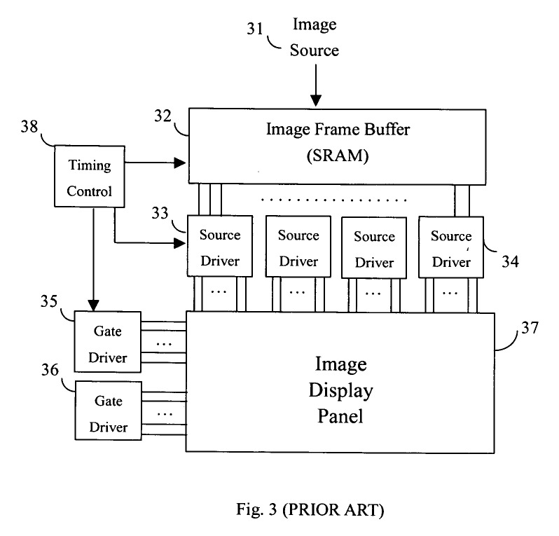

FIG. 3 details a prior art of display device driver, for example, said an LCD driver chip which comprised a timing control unit, a frame buffer, some source drivers and gate drivers. An image source 31 is received and temporarily saved in a frame buffer 32. In an SoC (System On Chip) high integration chip design, the frame buffer is comprised of SRAM (Static Random Access Memory) array for quick accessing. The timing control unit 38 calculates the time to display each row of pixels and controls pixels to drive out to be displayed. The gate drivers 35, 36 comprising some decoders which decide the row number of display. The gate driver is similar to the row driver in a memory array which selects the row number to be accessed in a memory array. Most likely the display starts from selecting the gate driver from top row down to bottom row sequentially. The source drivers 33, 34 drive out the pixels with each pixel column comprising three elements, said Red, Green and Blue to the display panel, for example, an LCD display panel 37. Therefore, the image to be displayed is saved in a frame buffer and to wait till the right time to start driving out line by line through the source drivers with the line (row) controlled by the gate drivers. For easy in design, low power consideration and automatic refreshing the display, the embedded frame buffer saves a whole frame of image which costs large area, for example, a 320×240 resolution of image requires 1.5M bits SRAM which dominates 70%˜80% of the die area of a display driver chip.

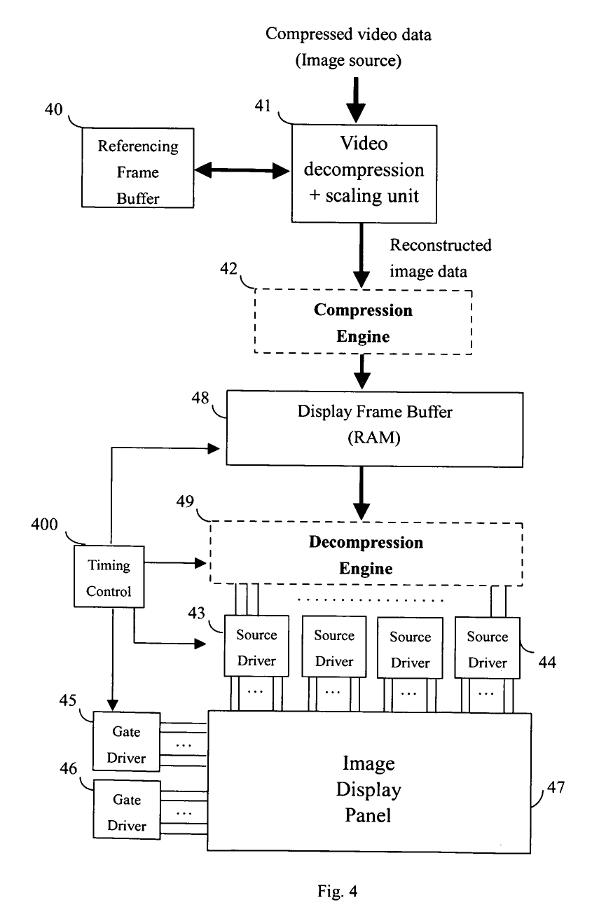

To eliminate the power dissipating in transferring data from the reconstructed frame to the display driver, this invention integrates the video decompression engine 41 with referencing frame buffer 40 into the display driver chip as shown in FIG. 4. Taking MPEG 4 or H.264 video compression algorithm as an example, 30 frame per second is a common frame rate, and the compression rate is ˜100× times, since the refreshing rate is 60 fps compared to the video frame rate of 30 fps, if the decompression is done by another device outside the display driver, the data amount needed to be transferred to the display driver will be 200× times more than transferring the compressed video data to the display device. Therefore, with this invention of transferring compressed video data and decompressing the video data on the same chip of the display driver saves 200× times power dissipated on the capacitive loading.

For saving the die area of the display frame buffer, this invention sends the reconstructed image to be displayed will be firstly compressed by a compression engine 42 before temporarily saving to the frame buffer 48 which is most likely comprised of an RAM memory array. When the timing of display reached, the corresponding line of pixels will be accessed and recovered by the decompression engine 49 and feed to the source drivers 43, 44 to be display onto the display panel 47. The gate drivers 45, 46 decide the row number for those corresponding row of pixels to be displayed on the display panel. A timing control unit 400 calculates the right timing of displaying the right line of pixels stored in the frame buffer, sends signal to the frame buffer and the decompression engine to inform the status of display, for instance, sending an “H-Sync” signal to represent a new line needs to be display within a certain time slot. When the decompression engine receives this signal, it starts accessing the frame buffer and decompressing the compressed pixel data and recovering the whole line of pixels, then, sending them to the source driver unit for display. The compression and decompression engine 42, 49 of the display frame buffer 48 adopts a whole frame of image pixels as a compression unit, also adopts a line of image pixels and a segment of image pixels as a unit of compression. When a frame pixels are defined as the group of compression unit, a predetermined compression rate, for example, said 4.0× is reached of reducing the frame data amount by a factor of 4.0 which is a significant die area and cost reduction. The decompressed video data can be converted to be Red, Green, Blue format before saving to the display image buffer. Any way, the YUV format with 4:2:2 YUV data ratio naturally saves 1.5× times data rate and costs less memory to store the compressed image. And the reconstructed YUV data from the display image buffer can also be transferred to be R, G, B format before sending to the display source driver to be displayed.

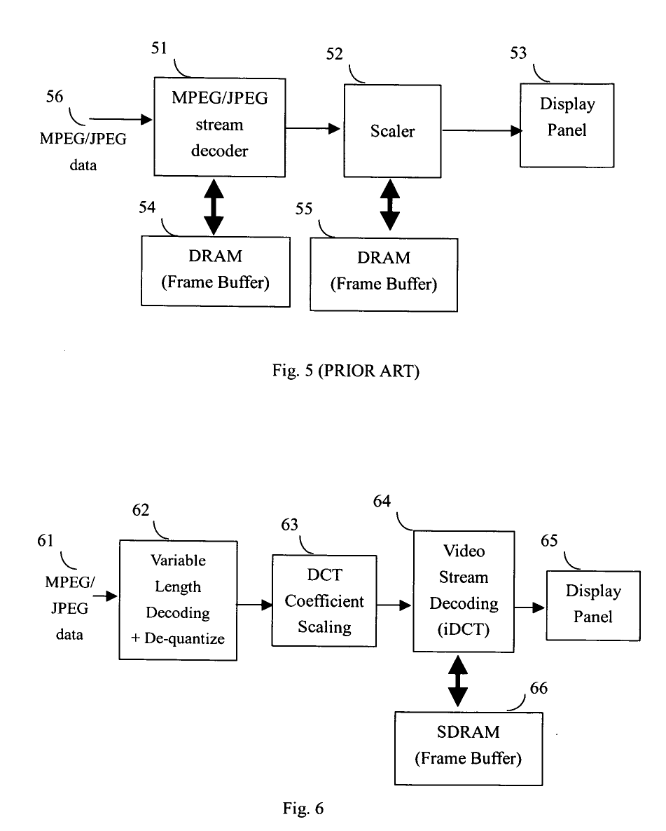

FIG. 5 illustrates the commonly used solution of decompressing a still image or a motion video stream and scaling it according to the resolution of the display device. An MPEG video or JPEG image 56 are decompressed by an decoder 51 with referencing to adjacent frame which is temporarily saved in a storage device 54. The larger the resolution of the compressed video, the larger amount of the referencing memory density will be required and the higher power will be consumed in transferring data between the decoder and the referencing memory. The reconstructed image will be stored in a temporary frame buffer 55 and the shape and size will be changed by a scaler 52 before outputting to a display device 53. In an embodiment of this invention, a variable length decoder 62 decodes the compressed image or video stream 61 and dequantized. The DCT coefficients of block pixels will then be scaled up or down according to the ratio of the resolution of the display device and the frame size of the image source. For instance, an image has 640×480 pixels of resolution, if the display device has resolution of 320×240 pixels, scaling at a ration of 2:1 in both X-axis and Y-axis will be required. The scaled image, will then be sent to an image or video decompression engine 64 to recover the image with help of referencing memory 66. This kind of mechanism reduces the requirements of memory 10 bandwidth and the power consumption in the case of the display resolution is smaller than the video stream. Should the image and video source has smaller resolution than the display device, then, no need for scaling and the compressed video or image directly goes to the decompression unit.

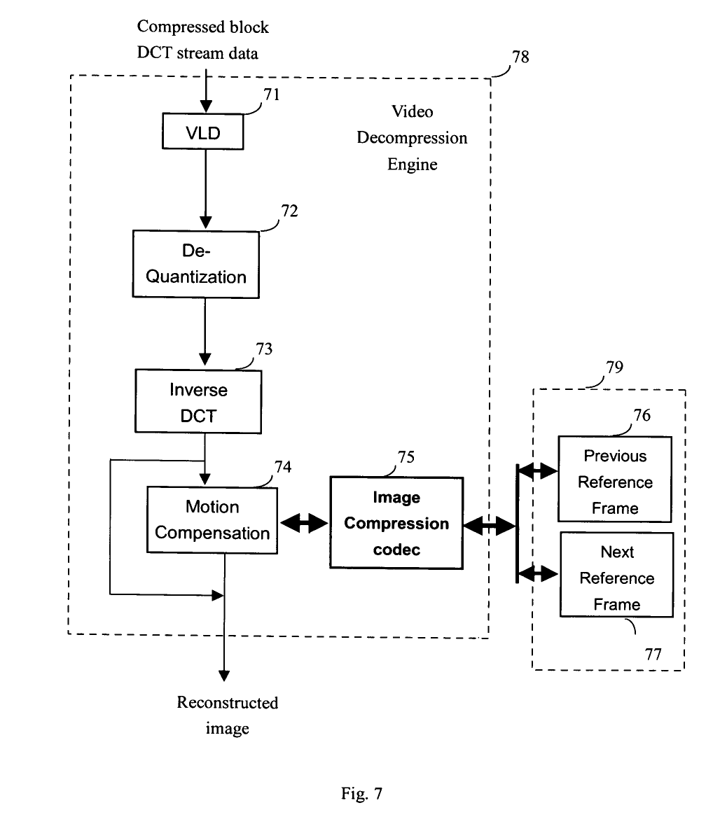

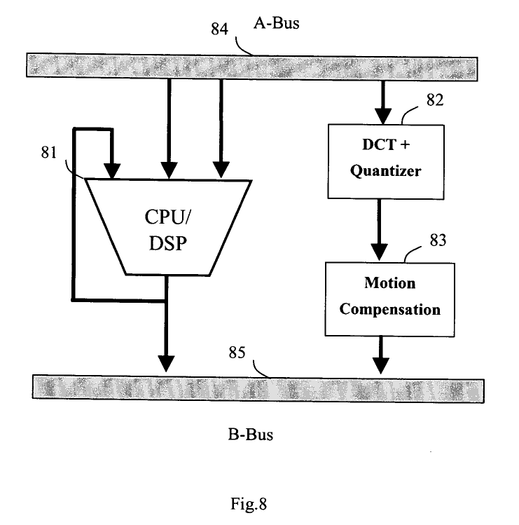

For further reducing the die area, power consumption and cost of temporary referencing memory buffer, this invention integrates an image compression codec residing between the video decompression engine 78 and the referencing frame buffer 79 as shown in FIG. 7. A compression rate of for example 2.0× times reduces the power consumption of accessing pixels, density requirement of referencing memory by a factor of 2 and making it on-chip frame buffer possible which completely eliminates the board capacitive loading. The compressed vide data is decoded by a stream parser which is a part of the video decompression engine. The video decompression engine is comprised of a variable length decoder 71, a de-quantization unit 72 which times the VLD decoded DCT coefficients with a matrix which is recovered by decoding the video stream in the stream decoding unit. The de-quantized DCT coefficients will be transformed from the frequency domain back to the time domain pixel data through the iDCT, the inversed DCT engine 73. In Intra-coded frame of a macro-block, the output of the iDCT can be the output of the decompression. In Inter-coding mode, the the iDCT output will input to the motion compensation engine 74 to reconstruct the pixel by adding the referencing block pixels stored in the referencing frame buffers 79 which comprised of at least one previous frame 76 and one next frame 77 of pixels. The image compression codec 75 reduces the data amount of referencing memory buffer by a predetermined factor, said 2.0× before sending the pixels into the referencing frame buffer 79 and decompressing the referencing frame buffer pixels before feeding to the decompression unit for motion compensation 74. For quick recovering the corresponding block pixels for motion compensation, an algorithm of block by block compression is applied to reduce the data rate with each block having the same output bit number which will be more easily in accessing and allocating from the display image buffer. With this invention of referencing frame buffer compression, the power consumption and gate count gets sharply reduced.

Since many video compression algorithms are updated very often, for keeping pace to the change of the video compression algorithms, one of the popular algorithms is to use a hardware accelerator coupled with a CPU or DSP engine. FIG. 8 shows an example of this approach. A CPU or DSP 81 controls the data flow and functions as some simple features which are not often happened like data packing, stream header, macro-block header decoding, the computing power hunger blocks like DCT 82 and motion compensation 83 are designed by hardware. All blocks including CPU/DSP and hardwired ASIC can hooked to data buses, A-Bus 84 or/and B-Bus 85.

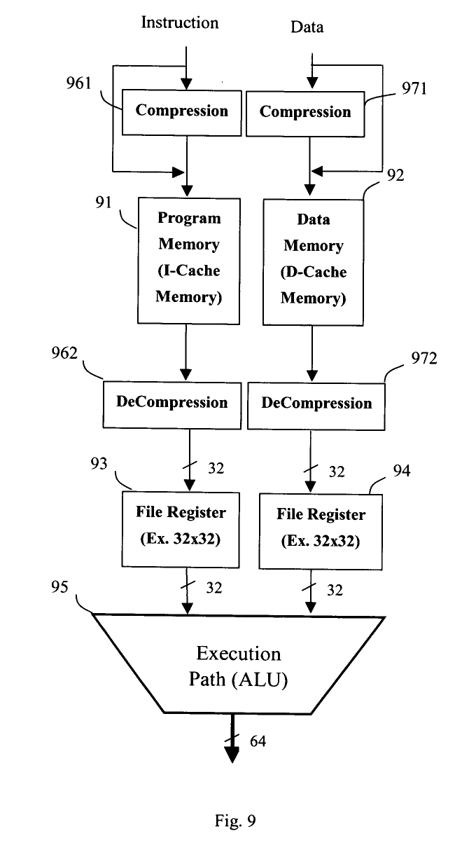

The CPU and DSP functions by executing so named “Instructions” which is saved in an embedded “Program Memory”. The program memory is most like implemented by RAM which consumes a lot die area, most likely much larger than the CPU/DSP core. Part of this invention is to reduce the die area by compressing the instructions hence cut down the density requirement of the program memory as shown in FIG. 9 A program is comprised a certain amount of “Instruction” sets and data which are the sources and codes of the CPU execution. An “Instruction” instructs the CPU what to work. The instructions of program are compressed 961 and saved in an on-chip program memory, or so called I-Cache memory 91, while the corresponding data which a program needs to execute are compressed 971 and saved in an on-chip data memory, or so called D-Cache memory 92. The source of instruction or data to the CPU or DSP can also be compressed by software which bypass the compression unit 91, 92 and directly save to the program memory. The “Caching Memory” might be organized to be large bank with heavy capacitive loading and relatively slow in accessing compared to the execution speed of the CPU execution logic, therefore, another temporary buffer of so named “File Register” 93, 94 with most likely smaller size, for example 32×32 (32 bits wide instruction or data times 32 rows) is placed between the CPU execution path 95 and the caching memory. A decompression unit 962 recovers the instruction before feeding to the file register 93. Another decompression unit 972 recovers the data and sends it to another file register 94. With this part of invention of compressing instructions, the density requirement of the program memory is significantly reduced and the capacitive loading gets smaller and dissipates less power. The CPU execution path will have some basic ALU functions like AND, NAND, OR, NOR, XOR, Shift, Round, Mod . . . etc, could also have multiplication and data packing, block data transferring and data aligning . . . features.

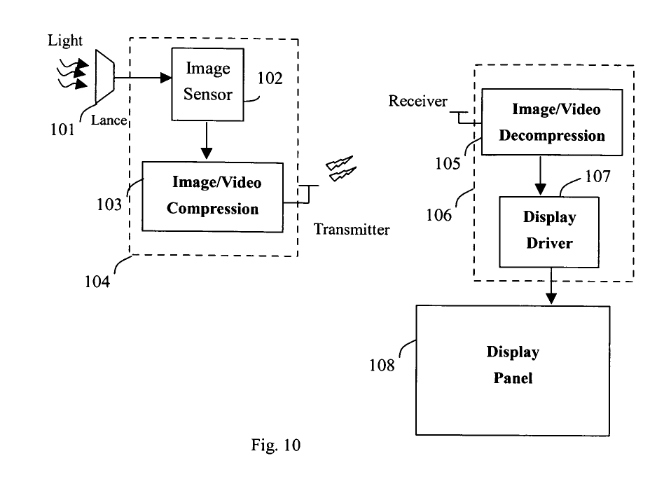

The common solution in video communication includes an image sensor chip, a video compress and decompression codec, a transceiver and a display device. Due to the fact that chip to chip capacitive loading dominates most the power consumption especially in multimedia applications. As shown in FIG. 10, this invention integrates the image sensor 102 and the video compression engine 103 into the same chip 104 which significantly reduces the power dissipated in the chip-to-chip capacitor since the compressed data rate is 100× times less compared to the uncompressed video data. In another part of this invention, the video decompression engine 105 is integrated in the display driver 107 which also significantly reduces the power consumption as described in previous paragraphs.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A device of video data decompression and displaying, comprising:
a decompression engine to reconstruct the compressed video data with a first storage device for temporarily saving the referencing frame image;
a second storage device functioning as a display frame buffer to temporarily save the reconstructed pixels to be driven out to be displayed;
an image compression codec to compress the image before saving into the second storage device of the display frame buffer and to decompress the pixels accessed from the display frame buffer before driving out to the display driver and display panel;
a timing control unit which determines the time to drive out the corresponding pixels to the display panel; and
a display driver comprising:
a source driver to drive out at least the Red, Green and Blue color components each pixel;
a gate driver to select the row of pixels to be driven out to the display panel.

2. The method of claim 1, wherein the compressed video source input to the video decompression engine is comprised of at least one of Y, Cr, Cb or Y, U, V elements with the data ratio of 4:2:2 or 4:2:0 or 4:4:4 format.

3. The method of claim 1, wherein the image source of the display image buffer is comprised of pixel data with YUV format and is converted to be Red, Green, Blue color elements before driving out to the display media.

4. The method of claim 1, wherein the source driver of the display driver drives out the pixels line by line with a line shifter coupled between the image decompression unit which reconstructs the pixels of the display image buffer and a line buffer.

5. A device of video data decompression, comprising:
a decompression engine to reconstruct the compressed video data including:
a variable length decoder to block by block decode and reconstruct the DCT coefficients;
de-quantization unit to multiply the DCT coefficients by the corresponding values of the quantization matrix to shift the DCT coefficients to the right values;
inverse DCT to transform the DCT coefficients to the time domain pixels in I-type coding or pixel differences in inter-frame coding; and
motion compensation unit to add the difference of block pixels to the block of pixels of the referencing frame in inter-frame coding;
a storage device for temporarily saving the referencing frame pixels; and
an image compression and decompression engine coupled between the video decompression engine and the referencing frame buffer to compress the image to be saved to the referencing frame buffer and to access the compressed image from the frame buffer and reconstruct them to be reference in the video decompression engine.

6. The device of claim 5, wherein a compression engine used to reduce the data rate of the referencing frame compresses the image block by block with each block pixels having the same output bit rate.

7. The device of claim 6, wherein a block is comprised of smaller amount of pixels compared to the block size for the motion compensation.

8. The device of claim 5, wherein the referencing frame buffer and the compression codec reside on the same die with the video decompression engine.

9. The device of claim 5, wherein the compressed video data is comprised of MPEG video compression data stream.

10. The device of claim 9, wherein the video compression engine compressed video data of Y, U, V or Y, Cr, Cb color components.

11. An apparatus of scaling, decompressing and displaying the video frame, comprising
a first decompression engine includes the video header decoder, a variable length decoder, and a dequantizer to recover the compressed frequency domain video data of DCT coefficients to block based information;
a scaler scales the video frame size according to the resolution of the display screen by re-calculating the DCT coefficients reconstructed by the first decompression engine;
a second decompression engine to block by block reconstruct the scaled video data includes the inverse DCT, and a motion compensation unit to add/subtract the block difference between the targeted block and the corresponding block of the referencing frame; and
a display driver which includes a timing controller unit to decide the time to driver out the corresponding pixels to the display panel, source and gate driver, an RAM temporarily storing the pixels to be driven out to the display panel and a still image codec engine to compress and decompress the image to be stored into the temporary image buffer.

12. The device of claim 11, wherein in the first decompression engine, the variable length decoding and de-quantization are applied to recover the DCT coefficients of block pixels.

13. The device of claim 11, wherein the timing control unit calculates the timing of driving out the corresponding pixels color elements of each row by sending signal to the gate drive, the source driver and the frame buffer of image regarding the right timing and location of frame pixels to be displayed.

14. A video communication device, comprising
A first device integrating image sensor and a video compression engine integrated on the same die;
A transceiver which transmits the compressed video data out which is generated from the first device and receives the compressed data and sends to the display device; and
A display device including a display panel and a display driver with the display image buffer and its corresponding compression codec and a video decompression unit integrated in the same die.

15. The device of claim 14, wherein the image sensor device is made of a semiconductor image sensing element.

16. The device of claim 14, wherein the semiconductor sensing element is a CMOS image sensor.

17. The device of claim 14, wherein the video compression engine includes a memory array storing at least one referencing frame buffer into the same die.

18. The device of claim 14, wherein the display driver includes a source driver driving out the pixels to the display panel, a gate driver selecting the row of pixels to be driven out and a timing controller deciding the time to drive the corresponding row of pixels.

19. The device of claim 14, wherein the video decompression engine includes a decompression engine, another compression codec to reduce the data rate of the referencing frame buffer and a memory array to temporarily save the compressed frame pixels.

20. The device of claim 14, wherein the reconstructed frame to be displayed is compressed by an engine before storing to the display image buffer and is decompressed before sending to the display driver.
